(19) United States
(12) Patent Application Publication
(10) Pub. No.: US 2025/0117509 A1
(43) Pub. Date: Apr. 10, 2025

(54) SYSTEMS AND METHODS FOR DYNAMICALLY GENERATING A FRICTION-BASED SECURITY DEVICE

(71) Applicant: Capital One Services, LLC, McLean, VA (US)

(72) Inventor: Shahalam BAIG, Rochester, NY (US)

(73) Assignee: Capital One Services, LLC, McLean, VA (US)

(21) Appl. No.: 18/905,202

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/62; G06F 21/32

(52) U.S. Cl. CPC G06F 21/6218; G06F 21/32

(57) ABSTRACT

Described are systems and methods for dynamically generating a friction-based security device, including receiving, via an application server, a first dataset, determining, via a trained machine learning model, a first friction level, wherein the trained machine learning model has been trained to predict a friction level based on at least one dataset, generating, via the application server, a first security device based on the first friction level, and causing to output, via a graphical user interface (“GUI”), the first security device.

### CROSS-REFERENCE TO RELATED APPLICATION(S)

This application claims the benefit of pending U.S. Provisional Patent Application No. 63/587,891, filed on Oct. 4, 2023, pending U.S. Provisional Patent Application No. 63/665,485, filed on Jun. 28, 2024, and pending U.S. Provisional Patent Application No. 63/683,063, filed on Aug. 14, 2024, all of which are incorporated herein by reference in their entireties.

### TECHNICAL FIELD

Various embodiments of this disclosure relate generally to dynamically generating a friction-based security device and, more particularly, to systems and methods for dynamically generating a friction-based security device based on user inputs.

### BACKGROUND

Organizations such as banks and healthcare providers seek to protect sensitive or confidential information (e.g., personally identifiable information (“PII”), financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, when the target is a user who uses a display screen (also referred to herein as a “screen”) of a computing device to view an account number on a bank's website, a social engineer using another computing device may attempt to persuade the user to reveal the account number to the social engineer. More specifically, the social engineer may convince the user to (i) share the user's screen (displaying the account number) with the social engineer using a screen sharing or remote desktop application, or (ii) take a screenshot of the user's screen (displaying the account number) using a screenshotting application, and then transmit the screenshot to the social engineer.

To guard against such social engineering, the bank may employ digital rights management (“DRM”) technologies, which are technologies that limit the use of digital content. However, the outputs or determinations of current DRM technologies may not be utilized in dynamically generating security elements to maximize security while minimizing user frustration.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for dynamically generating a friction-based security device.

In one aspect, a method for dynamically generating a friction-based security device is disclosed. The method may include receiving, via an application server, a first dataset, determining, via a trained machine learning model, a first friction level, wherein the trained machine learning model has been trained to predict a friction level based on at least one dataset, generating, via the application server, a first security device based on the first friction level, and causing to output, via a graphical user interface (“GUI”), the first security device.

In another aspect, a system is disclosed. The system may include at least one memory storing instructions and at least one processor operatively connected to the memory, and configured to execute the instructions to perform operations for dynamically generating a friction-based security device. The operations may include receiving, via an application server, a first dataset, determining, via a trained machine learning model, a first friction level, wherein the trained machine learning model has been trained to predict a friction level based on at least one dataset, generating, via the application server, a first security device based on the first friction level, and causing to output, via a graphical user interface (“GUI”), the first security device.

In another aspect, a method for dynamically generating a friction-based security device is disclosed. The method may include receiving, via an application server, a request for user authentication, upon receiving the request for user authentication, requesting a first dataset from a data storage, determining, via a trained machine learning model, a first friction level based on the first dataset, wherein the trained machine learning model has been trained to predict a friction level based on at least one dataset, the trained machine learning model having been trained to learn associations between training data to identify an output, the training data including a plurality of: at least one user input, user input data, an indication of digital extraction, screenshare activity, time on page, time to respond to security device, response to a security device, media content HTML manipulation, or responses to security devices, generating, via the application server, a first security device based on the first friction level, causing to output, via a GUI, the first security device, receiving, via the application server, one or both of a first user input associated with the first security device or a second dataset, based on the first user input or the second dataset, determining, via the trained machine learning model, a second friction level, generating, via the application server, a second security device based on one or both of the first friction level or the second friction level, and causing to output, via a GUI, the second security device.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for dynamically generating a friction-based security device, according to one or more embodiments.

FIG. 2 depicts an exemplary method for dynamically generating a friction-based security device, according to one or more embodiments.

FIG. 3 depicts an example machine learning training flow chart, according to some embodiments of the disclosure.

FIG. 4 depicts a simplified functional block diagram of a computer, according to one or more embodiments.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The term “user” or the like may refer to a person authorized to access an account, attempting to access an account, etc. As used herein, the term “social engineer” may be a person or entity who seeks to manipulate a target (e.g., a customer or employee of an organization) into divulging sensitive information that may be used for fraudulent purposes. That is, a social engineer is a person or entity who engages in social engineering.

As used herein, the phrase “media content” may represent a browser, a website, a webpage, etc. As used herein, the phrase “content element” may represent text data (e.g., letters, numbers, symbols, metadata, or alt text), image data (e.g., an image, a graphic, a sequence of image frames, or a video), audio data (e.g., a sequence of audio frames), or video data (e.g., a sequence of image frames). Further, a content element may represent data included in, or referred by, an HTML element of an HTML page corresponding to (or representing) the webpage. For example, a content element may be included in HTML used to structure the website, such as a Document Object Model (“DOM”), Cascading Style Sheets (“CSS”), etc. In some aspects, the content element may include or represent sensitive or confidential information (e.g., that may be displayed on a webpage (or webpage(s), website(s), portal(s) or application(s), etc.).

As used herein, the phrase “sensitive information” or “sensitive data” may refer to data that is intended for, or restricted to the use of, one or more users or entities (e.g., a user 105, an organization associated with a DRM-protection system 131, etc.). Moreover, sensitive data may represent data that is personal, private, confidential, privileged, secret, classified, or in need of protection, for example. Sensitive information may include personally identifiable information (“PII”) (e.g., a name, an address, a phone number, a social security number, etc.), financial information (e.g., an account number, an account balance, debits, credits, etc.), medical information (e.g., test results, appointments, medications, etc.), business information (e.g., proprietary information, trade secrets, etc.), government information (e.g., classified or secret information), any information a user may wish to not be shared with a third party, etc.

The phrase “hypertext markup language,” “HTML,” or the like may refer to a standardized system for tagging text files to achieve font, color, graphic, or hyperlink effects on World Wide Web pages. The phrase “HTML element” may represent a component of an HTML page, and may include, for example, a start tag and end tag, and as noted above, a content element or a reference to a content element (e.g., link, hyperlink, address, or path to a content element). Further, in some embodiments, an HTML element may include one or more HTML elements (e.g., nested HTML elements). As used herein, the term “pixel” may refer to the smallest element (or unit) of a display screen that can be programmed by (or manipulated through) software. In some embodiments, a pixel may include sub-pixels (e.g., a red sub-pixel, a green sub-pixel, and a blue sub-pixel) that emit light to create a color displayed on the display screen. In some aspects, the color may be included in, or represent, text data, image data, or video data presented on the display screen.

As used herein, the phrase “digital extraction” may refer to any process of copying content (e.g., audio, video, text, image, etc.), such as ripping, screensharing, screenshotting, etc. As used herein, the term “screenshare” or “screen share” may refer to a real time or near real time electronic transmission of data displayed on a display screen of a user's computing device to one or more other computing devices. The term “screensharing” or “screen sharing” and the phrase “being screenshared” or “being screen shared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” or “screen shot” may represent an image of data displayed on a display screen of a computing device, where the image may be captured or recorded. The term “screenshotting” or “screen shotting” and the phrase “being screenshotted” or “being screen shotted” may refer to capturing or recording a screenshot. In some aspects, screenshotting may be performed using a screenshotting application (e.g., the Snipping Tool in Microsoft Windows 11® or an application accessed using a Print Screen key of a keyboard or keypad).

As used herein, a “machine learning model” generally encompasses instructions, data, or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistical regression, random forest, gradient boosted machine (GBM), deep learning, or a deep neural network. Supervised or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, at least one security device may be generated based on predicted friction levels. Based on a combination of user inputs and various data points, a series of security devices may be generated and presented to a user (e.g., via a graphical user interface (“GUI”)). As the user provides responses to the security devices, a trained machine learning model may predict whether a friction level for a subsequent security device should increase or decrease. In some embodiments, at least one protective action may be initiated based on the user responses or the trained machine learning model's prediction.

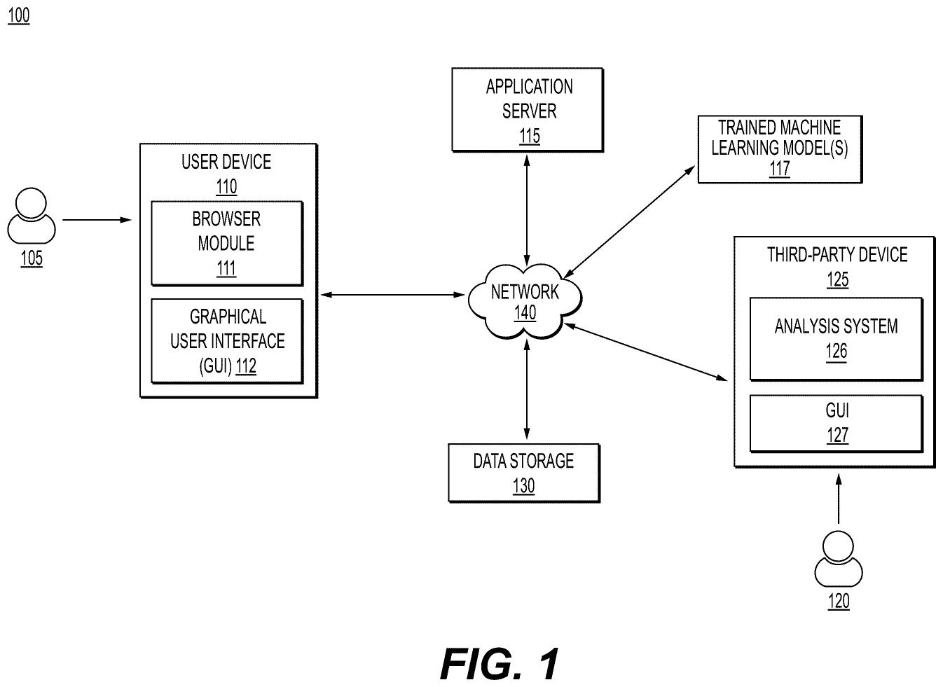

FIG. 1 depicts an example environment 100 that may be utilized with techniques presented herein. In some aspects, the environment 100 may be an embodiment of (i) environment 100 described in U.S. Provisional Application 63/587,891, filed on Oct. 4, 2023, (ii) environment 100 described in U.S. Provisional Application 63/665,485, filed on Jun. 28, 2024, or (iii) environment 100 described in U.S. Provisional Patent Application No. 63/683,063, filed Aug. 14, 2024 where each of these U.S. provisional applications is incorporated by reference herein in its entirety. FIG. 1 depicts an exemplary environment 100 for dynamically generating a friction-based security device, according to one or more embodiments. Environment 100 may include one or more aspects that may communicate with each other over a network 140, including, e.g., at least one memory storing instructions, and at least one processor operatively connected to the at least one memory and configured to execute the instructions to perform operations for dynamically generating a friction-based security device.

In some embodiments, a user 105 may interact with a user device 110 such that media content (e.g., a browser, a website, a webpage, etc.) including at least one content element may be loaded or a response to a security device may be input. As depicted in FIG. 1, a user 105 may be an individual authorized to use, access, etc. user device 110 or access, view, etc. sensitive information. User device 110 may interact with at least one of a browser module 111, a graphical user interface (“GUI”) 112, an application server 115, a trained machine learning model 117, a third-party device 125, an analysis system 126, a data storage 130, etc. User device 110 may be configured to enable user 105 to access or interact with other systems in environment 100.

In some embodiments, a third-party user 120 may interact with a third-party device 125 such that information associated with at least one user input may be managed. A third-party user 120 may be an individual associated with a third party, such as a third party facilitating, monitoring, etc. the DRM protections discussed herein. Third-party device 125 may be configured to enable third-party user 120 to access or interact with other systems in environment 100.

In some embodiments, user device 110 or third-party device 125 may be a computer system, e.g., a desktop computer, a laptop computer, a tablet, a smart cellular phone, a smart watch or other electronic wearable, etc. In some embodiments, user device 110 or third-party device 125 may include one or more electronic applications, e.g., a program, plugin, browser extension, etc., installed on a memory of user device 110 or third-party device 125. In some embodiments, the electronic applications may be associated with one or more of the other components in the environment 100.

User device 110 may include a browser module 111 or a graphical user interface (“GUI”) 112. User device 110—or the one or more aspects of user device 110, e.g., browser module 111, GUI 112, etc.—may be configured to obtain data from one or more aspects of environment 100. For example, user device 110 may be configured to receive data from browser module 111, GUI 112 (e.g., via one or more inputs from user 105), application server 115, trained machine learning model(s) 117, third-party device 125, analysis system 126, GUI 127 (e.g., via one or more inputs from third-party user 120), data storage 130, etc. User device 110 may be configured to transmit data to one or more aspects of environment 100, e.g., to browser module 111, GUI 112, application server 115, trained machine learning model(s) 117, third-party device 125, analysis system 126, GUI 127, data storage 130, etc.

Browser module 111 may be configured to determine whether digital extraction is indicated. In some embodiments, browser module 111 may be configured to detect, analyze, or transmit (e.g., to application server 115) an indication of digital extraction (e.g., screensharing, screenshotting, screen capture, etc.). In some embodiments, browser module 111 may be configured to receive the indication of digital extraction from other aspects of environment 100, such as user device 110, application server 115, data storage 130, etc. In some embodiments, browser module 111 may be configured to detect digital extraction based on indirect measures of digital extraction. For example, browser module 111 may be configured to detect user input(s) that may be indicative of screenshotting, such as simultaneously pressing and releasing the lock button and the volume up button on a social engineer's user device. In another example, browser module 111 may be configured to detect user input(s) that may be indicative of screensharing, such as inaccurate or delayed responses to a security device. In some embodiments, browser module 111 may be configured to infer or predict digital extraction may be occurring. For example, browser module 111 may be configured to determine a screensharing application, such as Zoom®, may be operating on a user device (e.g., user device 110) while a user (e.g., user 105) is providing at least one user input (e.g., via GUI 112). Browser module 111 may be configured to determine the indication of digital extraction based on the simultaneous operation of the screensharing application and the accessing sensitive information on user device 110.

Browser module 111 may be configured to generate a request for user authentication. For example, a security device may be associated with a media content or a content element, such that when a user (e.g., user 105) interacts with the media content or content element, the request for user authentication may be generated by browser module 111. Browser module 111 may transmit the request for user authentication (e.g., to application server 115).

Browser module 111 may be configured to obtain data from one or more aspects of environment 100. For example, browser module 111 may be configured to receive data from user device 110, GUI 112 (e.g., via one or more inputs from user 105), application server 115, trained machine learning model(s) 117, third-party device 125, analysis system 126, GUI 127 (e.g., via one or more inputs from third-party user 120), data storage 130, etc. Browser module 111 may be configured to transmit data to one or more aspects of environment 100. For example, browser module 111 may be configured to transmit data to user device 110, GUI 112, application server 115, trained machine learning model(s) 117, third-party device 125, analysis system 126, GUI 127, data storage 130, etc.

GUI 112 may be configured to cause to output the at least one security device (e.g., a first security device, a second security device, a third security device, etc.). GUI 112 may be configured to receive at least one user input (e.g., a first user input, a second user input, a third user input, etc.). For example, GUI 112 may be configured to receive a first user input in associated with a first security device, a second user input in associated with a second security device, a third user input in associated with a third security device, etc.

GUI 112 may be configured to obtain data from one or more aspects of environment 100. For example, GUI 112 may be configured to receive data from user device 110, browser module 111, application server 115, trained machine learning model(s) 117, third-party device 125, analysis system 126, GUI 127 (e.g., via one or more inputs from third-party user 120), data storage 130, etc. GUI 112 may be configured to transmit data to one or more aspects of environment 100. For example, GUI 112 may be configured to transmit data to user device 110, browser module 111, application server 115, trained machine learning model(s) 117, third-party device 125, analysis system 126, GUI 127, data storage 130, etc.

Application server 115 may be configured to retrieve at least one dataset (e.g., from data storage 130). The at least one dataset may include at least one of at least one user input (e.g., a response to a security device, a selection, etc.); user input data (e.g., the content of a user input, the timing of a user input, the order of a user input, individual baseline data, etc.); an indication of digital extraction (e.g., screenshare activity); time spent on a webpage, website, etc.; time to respond to a security device; media content HTML manipulation; etc. Individual baseline data may include data relating to a user's historical interactions, e.g., with a media content. Individual baseline data may include an indication of a new device, an indication of a new Internet Protocol (“IP”) address, an indication of a new browser, an indication of a new interaction type, etc. Media content HTML manipulation may include at least one of a window focus change, a window blur change, an editing pane activation (e.g., JavaScript® editing pane activation), an editing pane deactivation (e.g., JavaScript® editing pane deactivation), an editing pane width change (e.g., JavaScript® editing pane width change), an editing pane height change (e.g., JavaScript® editing pane height change), etc. For example, if JavaScript® editing pane activation is detected, application server 115 may be configured to detect media content HTML manipulation may be indicated.

In some embodiments, application server 115 may be configured to retrieve the at least one dataset based on the request for user authentication, at least one user input, etc. For example, application server 115 may be configured to request a first dataset based on the request for user authentication. In another example, application server 115 may be configured to request a second dataset based on a first user input. In a further example, application server 115 may be configured to request a third dataset based on a second user input. It should be noted that any number or combination of datasets may be retrieved based on the request for user authentication, at least one user input, etc. Further, the composition of each of the at least one dataset may vary or include overlapping information. For example, a first dataset generated based on the request for user authentication may contain different information than a second dataset generated based on a first user input. In another example, a first dataset generated based on the request for user authentication and a second dataset generated based on a first user input may include some similar data and some different data.

Application server 115 may be configured to generate at least one security device (e.g., a first security device, a second security device, a third security device, etc.). The at least one security device may be at least one of a Completely Automated Public Turing test to tell Computers and Humans Apart (“CAPTCHA”), a toggle, a button, a code verification element, two-factor authentication, a button disable through a key, console usage, input obfuscation, or any other suitable device. The button disable through a key may include a drag interface shown to unlock a button that is different while screensharing is active. The console usage may include an Event Listener waiting for the console to be opened or activated. The input obfuscation may include blocking the display of input characters while screensharing is active (e.g., using DRM technologies).

Each of the at least one security device may be associated with a friction level. The friction level may be the level of security (or resistance) provided by the security device. The friction level for a given security device may be determined relative to other available security devices. For example, a CAPTCHA may have a higher friction level than a toggle. In another example, two-factor authentication may have a higher friction level than a CAPTCHA. As discussed in greater detail below, the friction level may be determined by a trained machine learning model (e.g., trained machine learning model(s) 117).

In some embodiments, application server 115 may be configured to generate the at least one security device based on the request for authentication, at least one friction level, at least one user input, at least one dataset, etc. For example, a first security device may be generated based on one or both of the request for authentication or a first friction level. In another example, a second security device may be generated based on at least one of the request for authentication, the first user input, the first friction level, or a second friction level. In a further example, a third security device may be generated based on at least one of the request for authentication, the first user input, a second user input, the first friction level, the second friction level, or the third friction level.

In some embodiments, application server 115 may be configured to generate a security device relative to another security device's friction level. For example, where application server 115 has determined that a second friction level is lower than the first friction level, application server 115 may be configured to generate the second security device such that the second security device has a lower friction level than the first security device. In other words, if application server 115 has determined that a second friction level is lower than the first friction level, the second security device may include a toggle if the first security device included a CAPTCHA. In another example, where application server 115 has determined that a second friction level is higher than the first friction level, application server 115 may be configured to generate the second security device such that the second security device has a higher friction level than the first security device. In other words, if application server 115 has determined that a second friction level is higher than the first friction level, the second security device may include two-factor authentication if the first security device included a CAPTCHA.

Application server 115 may be configured to obtain data from one or more aspects of environment 100. For example, application server 115 may be configured to receive data from user device 110, browser module 111, GUI 112 (e.g., via one or more inputs from user 105), trained machine learning model(s) 117, third-party device 125, analysis system 126, GUI 127 (e.g., via one or more inputs from third-party user 120), data storage 130, etc. Application server 115 may be configured to transmit data to one or more aspects of environment 100. For example, application server 115 may be configured to transmit data to user device 110, browser module 111, GUI 112, trained machine learning model(s) 117, third-party device 125, analysis system 126, GUI 127, data storage 130, etc.

Trained machine learning model(s) 117 may be configured to determine at least one friction level (e.g., a first friction level, a second friction level, a third friction level, etc.). Trained machine learning model(s) 117 may be configured to determine at least one friction level based on at least one of: the request for user authentication, the at least one dataset (e.g., the first dataset, the second dataset, a third dataset, etc.), the at least one user input (e.g., the first user input, the second user input, a third user input, etc.), etc. For example, if a user (e.g., user 105) inputs an incorrect response to the first security device, trained machine learning model(s) 117 may predict that a second security element at a higher friction level may be necessary. In another example, if a user (e.g., user 105) quickly inputs a correct response to the first security device, trained machine learning model(s) 117 may predict that a second security device is not necessary or, if a second security device is to be used, the second security device may have a lower friction level than the first security device. In a further example, where a user (e.g., user 105) responded incorrectly to both a first security device and a second security device, trained machine learning model(s) 117 may predict that digital extraction may be indicated, an recommend at least one protection measure be initiated. Trained machine learning model(s) 117 may be configured to transmit the recommendation at least one protection measure be initiated (e.g., to analysis system 126).

In some embodiments, a system or device other than trained machine learning model(s) 117 may be used to generate or train the machine learning model. For example, such a system may include instructions for generating the machine learning model, the training data and ground truth, or instructions for training the machine learning model. A resulting trained machine learning model may then be provided to trained machine learning model(s) 117.

Generally, a machine learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training or used to validate the trained machine learning model, e.g., compare the output of the trained model with the ground truth for that portion of the training data to evaluate an accuracy of the trained model. The training of the machine learning model may be configured to cause the machine learning model to learn associations between training data and ground truth data, such that the trained machine learning model may be configured to determine an output illegitimate activity alert in response to the input user marker data based on the learned associations.

Trained machine learning model(s) 117 may include training data, for example, a plurality of: at least one of at least one user input (e.g., a response to a security device, a selection, etc.); user input data (e.g., the content of a user input, the timing of a user input, the order of a user input, etc.); an indication of digital extraction (e.g., screenshare activity); time spent on a webpage, website, etc.; time to respond to a security device; media content HTML manipulation; etc. Trained machine learning model(s) 117 may include ground truth, for example: at least one of at least one user input, user input data, an indication of digital extraction, time spent on a webpage, website, etc., time to respond to a security device, media content HTML manipulation, etc.

In some instances, different samples of training data or input data may not be independent. Thus, in some embodiments, the machine learning model may be configured to account for or determine relationships between multiple samples. For example, in some embodiments, the machine-learning model of marker analysis system 119 may include a Recurrent Neural Network (“RNN”). Generally, RNNs are a class of feed-forward neural networks that may be well adapted to processing a sequence of inputs. In some embodiments, the machine learning model may include a Long Short-Term Memory (“LSTM”) model or Sequence to Sequence (“Seq2Seq”) model. An LSTM model may be configured to generate an output from a sample that takes at least some previous samples or outputs into account. A Seq2Seq model may be configured to, for example, receive a sequence of user marker levels as input, and generate an illegitimate activity prediction as output.

Trained machine learning model(s) 117 may obtain data from one or more aspects of environment 100, e.g., from user device 110, browser module 111, GUI 112 (e.g., via one or more inputs from user 105), application server 115, third-party device 125, analysis system 126, GUI 127 (e.g., via one or more inputs from user 120), data storage 130, etc. Trained machine learning model(s) 117 may transmit data to one or more aspects of environment 100, e.g., to user device 110, browser module 111, GUI 112, application server 115, third-party device 125, analysis system 126, GUI 127, data storage 130, etc.

Third-party device 125 may be configured to enable user 120 to access or interact with other systems in the environment 100. Third-party device 125 may include a digital rights management (“DRM”)-protection system 126 (e.g., an analysis system) or a GUI 127. Third-party device 125—or the one or more aspects of third-party device 125, e.g., analysis system 126, GUI 127, etc.—may be configured to obtain data from one or more aspects of environment 100. For example, third-party device 125 may be configured to receive data from user device 110, browser module 111, GUI 112 (e.g., via one or more inputs from user 105), application server 115, trained machine learning model(s) 117, analysis system 126, GUI 127 (e.g., via one or more inputs from user 120), data storage 130, etc. Third-party device 125 may be configured to transmit data to one or more aspects of environment 100, e.g., to user device 110, browser module 111, GUI 112 (e.g., via one or more inputs from user 105), application server 115, trained machine learning model(s) 117, analysis system 126, GUI 127 (e.g., via one or more inputs from user 120), data storage 130, etc.

Analysis system 126 may be configured to implement at least one protective measure. The at least one protective measure may be configured to protect (or safeguard) a content element, sensitive information, etc. The at least one protective measure may include at least one of pausing, locking, canceling, etc. an account (e.g., a financial account) associated with the sensitive information, pausing a current financial transaction, pausing subsequent financial transactions, transmitting the at least one alert (e.g., to GUI 112), etc. In some embodiments, analysis system 126 may be configured to implement the at least one protective measure based on at least one of the at least one user input (e.g., the first user input, the second user input, the third user input, etc.), detection of the HTML modification event, the indication of digital extraction, the recommend at least one protection measure be initiated (e.g., from trained machine learning model(s) 117), etc. For example, if a JavaScript® editing pane height change is detected, analysis system 126 may be configured to lock (or freeze) a checking account associated with the checking account number as a precautionary measure. In another example, where a user (e.g., user 105) responded incorrectly to both a first security device and a second security device while attempting to initiate a wire transfer, analysis system 126 may be configured to reject the wire transfer.

Analysis system 126 maybe configured to obtain data from one or more aspects of environment 100. For example, analysis system 126 may be configured to receive data from user device 110, browser module 111, GUI 112 (e.g., via one or more inputs from user 105), application server 115, trained machine learning model(s) 117, third-party device 125, GUI 127 (e.g., via one or more inputs from user 120), data storage 130, etc. Analysis system 126 may be configured to transmit data to one or more aspects of environment 100, e.g., to user device 110, browser module 111, GUI 112, application server 115, trained machine learning model(s) 117, third-party device 125, GUI 127, data storage 130, etc.

GUI 127 maybe configured to obtain data from one or more aspects of environment 100. For example, GUI 127 may be configured to receive data from user device 110, browser module 111, GUI 112 (e.g., via one or more inputs from user 105), application server 115, trained machine learning model(s) 117, third-party device 125, analysis system 126, data storage 130, etc. GUI 127 may be configured to transmit data to one or more aspects of environment 100, e.g., to user device 110, browser module 111, GUI 112, application server 115, trained machine learning model(s) 117, third-party device 125, analysis system 126, data storage 130, etc.

Data storage 130 may be configured to receive data from other aspects of environment 100, such as from user device 110, browser module 111, GUI 112 (e.g., via one or more inputs from user 105), application server 115, trained machine learning model(s) 117, third-party device 125, analysis system 126, GUI 127 (e.g., via one or more inputs from user 120), etc. Data storage 130 may be configured to transmit data to other aspects of environment 100, such as to user device 110, browser module 111, GUI 112, application server 115, trained machine learning model(s) 117, third-party device 125, analysis system 126, GUI 127, etc.

One or more of the components in FIG. 1 may communicate with each other or other systems, e.g., across network 140. In some embodiments, network 140 may connect one or more components of environment 100 via a wired connection, e.g., a USB connection between user device 110 and data storage 130. In some embodiments, network 140 may connect one or more aspects of environment 100 via an electronic network connection, for example a wide area network (WAN), a local area network (LAN), personal area network (PAN), a content delivery network (CDN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, application server 115 may be integrated in browser module 111. In another example, trained machine learning model(s) 117 may be integrated in analysis system 126. In some embodiments, operations or aspects of one or more of the components discussed above may be distributed amongst one or more other components, e.g., one or both of browser module 111 or application server 115.

In some embodiments, some of the components of environment 100 may be associated with a common entity, while others may be associated with a disparate entity. For example, browser module 111 and application server 115 may be associated with a common entity (e.g., an entity with which user 105 has an account) while data storage 130 may be associated with a third party (e.g., a provider of data storage services). Any suitable arrangement or integration of the various systems and devices of the environment 100 may be used.

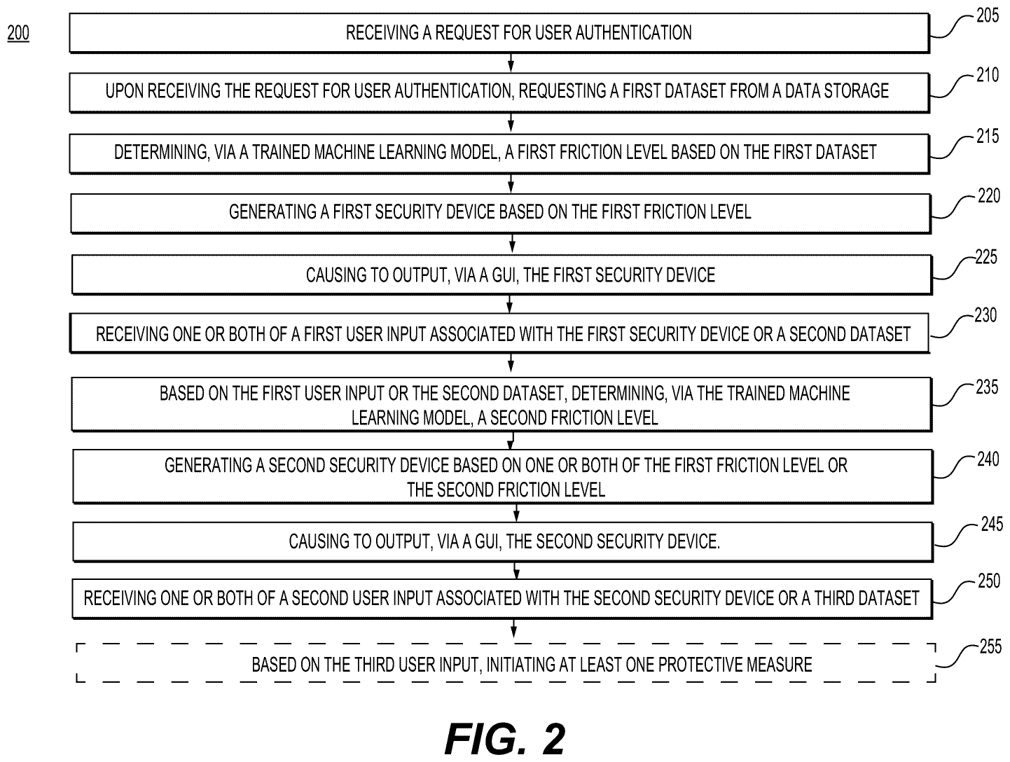

FIG. 2 depicts an exemplary method for dynamically generating a friction-based security device, according to one or more embodiments. As depicted in method 200 of FIG. 2, at step 205, a request for user authentication may be received (e.g., via application server 115). The request for user authentication may be generated (e.g., via browser module 111) based on the contents of a media content (e.g., a website). For example, if a media content is coded (e.g., via HTML) to include a security element, the request for user authentication may be generated (e.g., via browser module 111) upon loading the media content and transmitted (e.g., to application server 115).

At step 210, upon receiving the request for user authentication, a first dataset may be retrieved (e.g., from data storage 130). As discussed herein, the first dataset may be retrieved (or generated) based on the request for user authentication, at least one user input, etc. For example, a first dataset may be requested based on the request for user authentication. In another example, a second dataset may be request based on a first user input. In a further example, a third dataset may be requested based on a second user input.

Any number or combination of datasets may be retrieved based on the request for user authentication, at least one user input, etc. Further, the composition of each of the at least one dataset may vary or include overlapping information. For example, a first dataset generated based on the request for user authentication may contain different information than a second dataset generated based on a first user input. In another example, a first dataset generated based on the request for user authentication and a second dataset generated based on a first user input may include some similar data and some different data.

At step 215, a first friction level may be determined based on the first dataset (e.g., via trained machine learning model(s) 117). For example, if the first dataset indicates that media content HTML manipulation is present, it may be determined that the first friction level is high. In another example, if the first dataset does not indicate a presence of problematic indicia (e.g., media content HTML manipulation, long time spent on a webpage, long time to respond to a security device, etc.), it may be determined that the first friction level is low.

In some aspects, trained machine learning model(s) 117 may be trained to predict at least one friction level using training data or ground truth data. The training data may include, for example, a plurality of: at least one of at least one user input (e.g., a response to a security device, a selection, etc.); user input data (e.g., the content of a user input, the timing of a user input, the order of a user input, etc.); an indication of digital extraction (e.g., screenshare activity); time spent on a webpage, website, etc.; time to respond to a security device; media content HTML manipulation; etc. Ground truth data may include, for example, a plurality of: at least one of at least one user input, user input data, an indication of digital extraction, time spent on a webpage, website, etc., time to respond to a security device, media content HTML manipulation, etc.

At step 220, a first security device may be generated based on the first friction level (e.g., via application server 115). For example, if the first friction level is determined to be high, the first security device may include a device that has high friction, such as two-factor authentication, a CAPTCHA, etc. In another example, if the first friction level is determined to be low, the first security device may include a device that has low friction, such as a toggle, a button, etc.

At step 225, the first security device may be caused to be output (e.g., via GUI 112). The first security device may be caused to be output such that a user (e.g., user 105) may interact with the first security device (e.g., via GUI 112).

At step 230, one or both of a first user input associated with the first security device or a second dataset may be received (e.g., via application server 115). The first user input associated with the first security device may be received (e.g., via GUI 112) and transmitted (e.g., to application server 115). In some embodiments, upon receipt of the first user input, a second dataset may be retrieved (e.g., from data storage 130).

At step 235, a second friction level may be determined based on the first user input or the second dataset (e.g., via trained machine learning model(s) 117). For example, if the first dataset indicates that media content HTML manipulation is present and the user (e.g., user 105) provided an incorrect response to the first security device, it may be determined that the first friction level is high. In another example, if the first dataset does not indicate a presence of problematic indicia (e.g., media content HTML manipulation, long time spent on a webpage, long time to respond to a security device, etc.) and the user (e.g., user 105) provided a correct response to the first security device, it may be determined that the first friction level is low. In a further example, if the first dataset does not indicate a presence of problematic indicia (e.g., media content HTML manipulation, long time spent on a webpage, long time to respond to a security device, etc.) and the user (e.g., user 105) provided an incorrect response to the first security device, it may be determined that the first friction level is intermediate.

At step 240, a second security device may be generated based on one or both of the first friction level or the second friction level (e.g., via application server 115). In some embodiments, the second security device may be generated based on the second friction level. For example, if the second friction level is determined to be high, the second security device may be generated to include a device that has high friction, such as two-factor authentication, a CAPTCHA, etc.

In some embodiments, the second security device may be generated based on a comparison of the first friction level and the second friction level. For example, if the first friction level is determined to be low and the second friction level is determined to be high, the second security device may include a device that has high friction, such as two-factor authentication, a CAPTCHA, etc. In another example, if the first friction level is determined to be high and the second friction level is determined to be low, the second security device may include a device that has intermediate or low friction, such as a toggle, a button, etc. In further example, if the first friction level is determined to be high and the second friction level is determined to be high, it may be predicted that digital extraction is indicated and at least one protective measure may be initiated (see discussed of step 255 below).

At step 245, the second security device may be caused to be output (e.g., via GUI 112). The second security device may be caused to be output such that a user (e.g., user 105) may interact with the second security device (e.g., via GUI 112).

At step 250, one or both of a second user input associated with the second security device or a third dataset may be received (e.g., via application server 115). The second user input associated with the second security device may be received (e.g., via GUI 112) and transmitted (e.g., to application server 115). In some embodiments, upon receipt of the second user input, a third dataset may be retrieved (e.g., from data storage 130).

Optionally, at step 255, at least one protective measure may be initiated based on the third user input (e.g., via analysis system 126). In some embodiments, the at least one protective measure may be initiated (e.g., via analysis system 126) based on the request for user authentication, receipt of at least one user input, detection of the HTML modification event, the indication of digital extraction, etc. As discussed herein, the at least one protective measure may include at least one of pausing, locking, canceling, etc. an account (e.g., a financial account) associated with the sensitive information, pausing a current financial transaction, pausing subsequent financial transactions, transmitting the at least one alert (e.g., to GUI 112), etc. For example, where a user (e.g. user 105) is attempting to authorize a wire transfer, the current financial transaction and subsequent financial transactions may be paused upon the determination that the user (e.g., user 105) responded incorrectly to the first security device and the second security device.

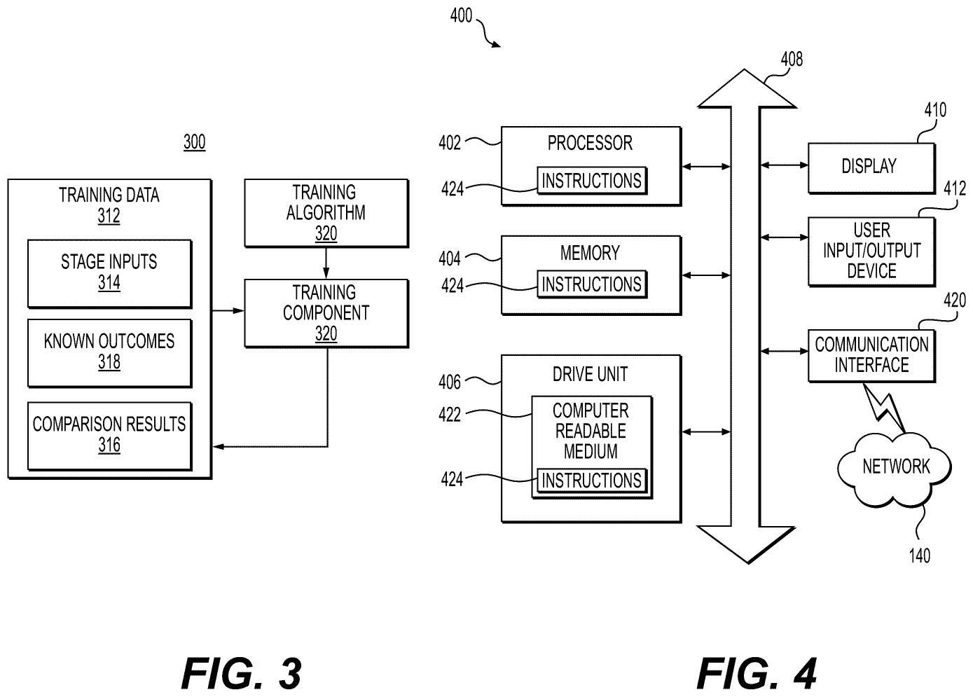

One or more implementations disclosed herein include or are implemented using a machine learning model (e.g., trained machine learning model(s) 117) are implemented using a machine learning model or are used to train the machine learning model. A given machine learning model may be trained using the training flow chart 300 of FIG. 3. The training data 312 may include one or more of stage inputs 314 and the known outcomes 318 related to the machine learning model to be trained. The stage inputs 314 are from any applicable source including text, visual representations, data, values, comparisons, and stage outputs, e.g., one or more outputs from one or more steps from FIG. 2. The known outcomes 318 are included for the machine learning models generated based on supervised or semi-supervised training. An unsupervised machine learning model is not trained using the known outcomes 318. The known outcomes 318 includes known or desired outputs for future inputs similar to or in the same category as the stage inputs 314 that do not have corresponding known outputs.

The training data 312 and a training algorithm 320, e.g., one or more of the modules implemented using the machine learning model or are used to train the machine learning model, is provided to a training component 330 that applies the training data 312 to the training algorithm 320 to generate the machine learning model. According to an implementation, the training component 330 is provided comparison results 316 that compare a previous output of the corresponding machine learning model to apply the previous result to re-train the machine learning model. The comparison results 316 are used by the training component 330 to update the corresponding machine learning model. The training algorithm 320 utilizes machine learning networks or models including, but not limited to a deep learning network such as a transformer, Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, or discriminative models such as Decision Forests and maximum margin methods, the model specifically discussed herein, or the like.

The machine learning model used herein is trained or used by adjusting one or more weights or one or more layers of the machine learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights or layers.

Conventionally, security devices are selected based on generalized security preferences. For example, one organization may always use CAPTCHA for authentication, regardless of whether higher or lower security is warranted. The techniques described herein maximize security while minimizing user frustration by customizing a security device based on real-time information. The techniques described herein enable user interactions with media content to be utilized in intelligently and dynamically increasing or decreasing security levels. As such, sensitive information may more effectively be protected and digital extraction may better be predicted.

FIG. 4 depicts a simplified functional block diagram of a computer 400 that may be configured as a device for executing the methods disclosed here, according to exemplary embodiments of the present disclosure. For example, the computer 400 may be configured as a system according to exemplary embodiments of this disclosure. In various embodiments, any of the systems herein may be a computer 400 including, for example, a data communication interface 420 for packet data communication. The computer 400 also may include a central processing unit (CPU) 402, in the form of one or more processors, for executing program instructions. The computer 400 may include an internal communication bus 408, and a storage unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 or computer readable medium 422). The computer 400 also may include input and output ports 412 or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention. The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for dynamically generating a friction-based security device, the method comprising:
receiving, via an application server, a first dataset;
determining, via a trained machine learning model, a first friction level, wherein the trained machine learning model has been trained to predict a friction level based on at least one dataset;
generating, via the application server, a first security device based on the first friction level; and
causing to output, via a graphical user interface (“GUI”), the first security device.

2. The method of claim 1, further comprising:
receiving, via the application server, a request for user authentication; and
upon receiving the request for user authentication, requesting the first dataset from a data storage.

3. The method of claim 1, further comprising:
receiving, via the application server, one or both of a first user input associated with the first security device or a second dataset;
based on the first user input or the second dataset, determining, via the trained machine learning model, a second friction level;
generating, via the application server, a second security device based on one or both of the first friction level or the second friction level; and
causing to output, via a GUI, the second security device.

4. The method of claim 3, wherein generating the second security device based on one or both of the first friction level or the second friction level further comprises:
determining, via the application server, the second friction level is higher than the first friction level; and
generating, via the application server, the second security device such that the second security device has a higher security level than the first security device.

5. The method of claim 3, wherein generating the second security device based on one or both of the first friction level or the second friction level further comprises:
determining, via the application server, the second friction level is lower than the first friction level; and
generating, via the application server, the second security device such that the second security device has a lower security level than the first security device.

6. The method of claim 3, further comprising:
receiving, via the application server, one or both of a second user input associated with the second security device or a third dataset;
based on the second user input or the third dataset, determining, via the trained machine learning model, a third friction level;
generating, via the application server, a third security device based on at least one of the first friction level, the second friction level, or the third friction level; and
causing to output, via a GUI, the third security device.

7. The method of claim 6, further comprising:
receiving, via the application server, a third user input associated with the third security device; and
based on the third user input, initiating at least one protective measure via an analysis system.

8. The method of claim 1, wherein the security device includes at least one of a Completely Automated Public Turing test to tell Computers and Humans Apart (“CAPTCHA”), a toggle, a button, or a code verification element.

9. The method of claim 1, wherein the dataset includes at least one of at least one user input, user input data, an indication of digital extraction, screenshare activity, time on page, time to respond to security device, response to a security device, or media content HyperText Markup Language (“HTML”) manipulation.

10. The method of claim 1, wherein the trained machine learning model has been trained to learn associations between training data to identify an output, the training data including a plurality of: at least one user input, user input data, an indication of digital extraction, screenshare activity, time on page, time to respond to security device, response to a security device, media content HTML manipulation, or responses to security devices.

11. A system, the system comprising:
at least one memory storing instructions; and
at least one processor operatively connected to the memory, and configured to execute the instructions to perform operations for dynamically generating a friction-based security device, the operations including:
receiving, via an application server, a first dataset;
determining, via a trained machine learning model, a first friction level, wherein the trained machine learning model has been trained to predict a friction level based on at least one dataset;
generating, via the application server, a first security device based on the first friction level; and
causing to output, via a graphical user interface (“GUI”), the first security device.

12. The system of claim 11, the operations further comprising:
receiving, via the application server, a request for user authentication; and
upon receiving the request for user authentication, requesting the first dataset from a data storage.

13. The system of claim 11, the operations further comprising:
receiving, via the application server, one or both of a first user input associated with the first security device or a second dataset;
based on the first user input or the second dataset, determining, via the trained machine learning model, a second friction level;
generating, via the application server, a second security device based on one or both of the first friction level or the second friction level; and
causing to output, via a GUI, the second security device.

14. The system of claim 13, wherein generating the second security device based on one or both of the first friction level or the second friction level further comprises:
determining, via the application server, the second friction level is higher than the first friction level; and
generating, via the application server, the second security device such that the second security device has a higher security level than the first security device.

15. The system of claim 13, wherein generating the second security device based on one or both of the first friction level or the second friction level further comprises:
determining, via the application server, the second friction level is lower than the first friction level; and
generating, via the application server, the second security device such that the second security device has a lower security level than the first security device.

16. The system of claim 13, the operations further comprising:
receiving, via the application server, one or both of a second user input associated with the second security device or a third dataset;
based on the second user input or the third dataset, determining, via the trained machine learning model, a third friction level;
generating, via the application server, a third security device based on at least one of the first friction level, the second friction level, or the third friction level; and
causing to output, via a GUI, the third security device.

17. The system of claim 16, the operations further comprising:
receiving, via the application server, a third user input associated with the third security device; and
based on the third user input, initiating at least one protective measure via an analysis system.

18. The system of claim 11, wherein the security device includes at least one of a Completely Automated Public Turing test to tell Computers and Humans Apart (“CAPTCHA”), a toggle, a button, or a code verification element.

19. The system of claim 11, wherein the dataset includes at least one of at least one user input, user input data, an indication of digital extraction, screenshare activity, time on page, time to respond to security device, response to a security device, or media content HTML manipulation.

20. A method for dynamically generating a friction-based security device, the method comprising:
receiving, via an application server, a request for user authentication;
upon receiving the request for user authentication, requesting a first dataset from a data storage;
determining, via a trained machine learning model, a first friction level based on the first dataset, wherein the trained machine learning model has been trained to predict a friction level based on at least one dataset, the trained machine learning model having been trained to learn associations between training data to identify an output, the training data including a plurality of: at least one user input, user input data, an indication of digital extraction, screenshare activity, time on page, time to respond to security device, response to a security device, media content HTML manipulation, or responses to security devices;
generating, via the application server, a first security device based on the first friction level;
causing to output, via a GUI, the first security device;
receiving, via the application server, one or both of a first user input associated with the first security device or a second dataset;
based on the first user input or the second dataset, determining, via the trained machine learning model, a second friction level;
generating, via the application server, a second security device based on one or both of the first friction level or the second friction level; and
causing to output, via a GUI, the second security device.
